(19) United States
(12) Patent Application Publication
(10) Pub. No.: US 2012/0151838 A1
(43) Pub. Date: Jun. 21, 2012

(54) Deep water culture receptacle

(76) Inventor: Edward Mattson, Lakeport, CA (US)

(21) Appl. No.: 13/373,913

(22) Filed: Dec. 5, 2011

Related U.S. Application Data
(60) Provisional application No. 61/458,953, filed on Dec. 6, 2010.

(51) Int. Cl. A01G 31/02

(52) U.S. Cl. 47/60; 47/59 R

(57) ABSTRACT

A receptacle for growing a plant or plants by submerging the roots in a solution. The receptacle is novel and useful yet unobvious because it employs a unique method for verifying the solution level via a transparent section or sections which is more rapid, leak free, and preventative of microorganism growth, yet, permits for the necessary aeration and evaporation control. The remainder of the receptacle is opaque to prevent an undesirable amount of light from penetrating the receptacle.

### RELATED US APPLICATION

This application claims the benefit under 35 USC 119(e) of prior U.S. Provisional Application No. 61/458,953, titled “Deep Water Culture Receptacle,” filed on Dec. 6, 2010 which is incorporated herein by reference in its entirety.

### BACKGROUND OF THE INVENTION

1. Field of the Invention

This invention relates to deep water culture, also known as Bubbleponics. Deep water culture is a way to grow a plant by submerging its roots into a receptacle which contains a nutrient rich solution. An airline, air stone, pump line, or equivalent is additionally located inside the reservoir to provide the plant with an air supply and maintain the solution volume. The air supply allows the nutrient rich solution to be aerated while the roots of the plant are submerged. A novel, useful and unobvious deep water culture receptacle is the subject matter of this invention. Said receptacle may be used in the singular or in the multiple as an interconnected system.

2. Description of the Related Art

Prior plant receptacles, with and without air supplies have been patented; however, deep water culture receptacles remain plagued with problems and inefficiencies. The need for an improved method for cultivating a plant under deep water culture conditions exists.

The present invention is novel and useful yet unobvious because, in addition to the other elements necessary for deep water culture, it employs' a unique method for verifying the solution level which is more rapid and leak free, yet, said method is not readily accepted by deep water culture experts.

The following prior patents are relevant as follows:

Spray U.S. Pat. No. 7,730,666 B2 discloses a plant container with a water level viewing system, however, does not disclose use of an enclosed system or lid for regulating volume lost to evaporation. Moreover, the present invention discloses a system of air and pump lines for aeration and solution volume control whereas U.S. Pat. No. 7,730,666 B2 does not provide for aeration and specifically claims funnel regions for receiving water.

Shi U.S. Pub. No. 2006/0207175A1 discloses a flowerpot with a water level viewing system comprising a hole in the side said flowerpot for pouring water through and does not disclose use of an enclosed system or lid for regulating volume lost to evaporation or air and pump lines.

Byron, et. al. U.S. Pat. No. 6,497,071 discloses a Christmas tree stand which is a self-watering system purposed to hydrate cut Christmas trees, however, does not disclose a system purposed to grow live plants or aerate plant roots via air and pump lines.

Ho U.S. Pat. No. 6,322,871 B1 discloses a design of planter inserts and water reservoirs comprising a curved neck and does not disclose use of an enclosed system or lid for regulating volume lost to evaporation or air and pump lines.

Kang U.S. Pat. No. 6,22,921 B1 discloses a self-watering planter with a water level monitoring system comprising a filler tube, however, said system comprises a floating devise rather than a transparent section of the receptacle.

Scannell U.S. Pat. No. 6,279,265 B1 discloses a plant pot with a water level control device, however, does not disclose use of an enclosed system or lid for regulating volume lost to evaporation or air and pump lines.

Smith U.S. Pat. No. 5,921,025 discloses a self-watering plant pot, however, does not disclose use of an enclosed system or lid for regulating volume lost to evaporation or air and pump lines.

Ellis-El U.S. Pat. No. 5,596,839 discloses a modified long term self feeding planter, however, does not disclose use of an enclosed system or lid for regulating volume lost to evaporation or air and pump lines..

Deutschmann U.S. Pat. No. 5,107,621 discloses a hydroculture growing system with an improved light/water meter, however, does not disclose use of an enclosed system or lid for regulating volume lost to evaporation or air and pump lines.

Hobson U.S. Pat. No. 4,916,858 discloses a self-watering planter, however, does not disclose use of an enclosed system or lid for regulating volume lost to evaporation or air and pump lines.

Block U.S. Pat. No. 4,895,254 discloses a tank-plant vessel-combination with water-level indicator as device for long term water supply for various types of plant cultures, however, said system comprises a floating devise rather than a transparent section of the receptacle.

Luis U.S. Pat. No. 4,538,378 discloses a plant container, however, does not disclose use of an enclosed system or lid for regulating volume lost to evaporation or air and pump lines.

Raap U.S. Pat. No. Des. 257,529 discloses a combined plant pot liner and water level gauge, however, does not disclose use of an enclosed system or lid for regulating volume lost to evaporation or air and pump lines.

Bigglestone U.S. Pat. No. 4,171,593 discloses a pot including a water level indicator, however, does not disclose use of an enclosed system or lid for regulating volume lost to evaporation.

Bridwell U.S. Pat. No. 4,055,991 discloses a liquid gauge assembly, however, said system comprises a floating devise rather than a transparent section of the receptacle.

Baumann U.S. Pat. No. 4,270,309 discloses a plant receiving vessel for insertion in a hydroponic vessel, however, does not disclose a system itself purposed to grow live plants.

Baumann U.S. Pat. No. 3,988,857 discloses an accessory unit for hydroponics receptacles, however, does not disclose a system itself purposed to grow live plants.

Carlson U.S. Pat. No. 3,243,919 discloses an irrigating plant receptacle, however, does not disclose use of an enclosed system or lid for regulating volume lost to evaporation or air and pump lines.

O'Rourke U.S. Pat. No. 1,347,398 discloses new and useful improvements in douche-cans, however, does not disclose use of an enclosed system or lid for regulating volume lost to evaporation or air and pump lines.

### BRIEF SUMMARY OF THE INVENTION

The present invention provides a receptacle for growing a plant or plants by submerging the roots in a solution. Said solution may be nutrient rich upon submersion or become nutrient rich after submersion. Said solution can also be aerated and its volume controlled via the present invention. The receptacle is equipped with at least one transparent section which allows the water level inside the receptacle to be assessed from the outside. The transparent section(s) is integrated into the receptacle to allow assessment of the internal liquid level from the exterior of the receptacle. Accordingly, the remainder of the receptacle is opaque. One benefit of the opaque remainder of the receptacle is that can prevent an undesirable amount of light from penetrating the receptacle. Microorganisms may potentially grow inside of similar receptacles if an undesirable amount of light penetrates said receptacles. The present invention limits microorganism growth.

The existing deep water culture receptacle that is commonly used has a hole at the bottom. Generally, a plastic elbow is inserted in this hole and then sealed with a rubber washer. Then, a vertical tube is added which shows the water level as it rises in the receptacle. This system is insufficient because if the seal should come loose or wear out, the solution will drain out of the receptacle. In addition to allowing undesirable leakage and potentially destroying the plant, the old systems may require movement of the lid to identify the solution level.

The present invention will never leak since the receptacle does not require a hole in the bottom of the receptacle for assessing the solution level. Moreover, the present invention will never require lifting of the lid to assess the solution level since said level can be viewed through a transparent section of the receptacle. When multiple receptacles are in use, the ability to assess the solution level quickly is an essential time saving advantage.

The present invention is unobvious because those skilled in the field assert that transparent segments in Deep Water Culture receptacles allow an undesirable quantity of light to pass into the receptacle. Those skilled in the field assert that this light would lead to algae buildup. However, the present invention proves that this is not the case. The invention has been tested and said algae buildup has never occurred.

### BRIEF DESCRIPTION OF THE FIGURES

The present invention is described with reference to the accompanying drawings. In the drawings, like reference numbers indicate identical or functionally similar elements.

FIG. 1 is a front side view of an exemplary receptacle in accordance with the present invention.

FIG. 2 is a top view of an exemplary receptacle in accordance with the present invention.

FIG. 3 is a front view of an exemplary receptacle with air and pump notches in accordance with the present invention.

FIG. 4 is a front view of the preferred embodiment of the invention.

FIG. 5 is a side view of the preferred embodiment of the invention.

### DETAILED DESCRIPTION OF THE INVENTION

### Section I: Definitions

“Deep Water Culture” refers to a way to grow a plant by submerging its roots into a receptacle which contains an aerated nutrient rich solution.

“Notches” refer to cutouts, holes, or any other structural form which enables attachment of air and pump lines to the receptacle.

“Nutrient Rich Solution” refers to either a solution present when said plant roots are submersed or additives/an additive solution which is later added to the receptacle to facilitate plant growth.

“Opaque” refers to a state of disallowing light, specifically ultraviolet light or any other wavelength which stimulates chlorophyll and/or facilitates microorganism growth, to pass through.

“Receptacle” refers to a container or containers which encapsulates the plant roots and nutrient rich solution to provide for volume, evaporation, and nutrient control. The receptacle can be comprised of one piece or multiple pieces.

“Transparent” refers to a state of allowing assessment of the internal solution level from the outside of the receptacle.

Reference will now be made in detail to preferred embodiments of the invention. While the invention will be described in conjunction with the preferred embodiments, it will be understood that it is not intended to limit the invention to those preferred embodiments. To the contrary, it is intended to cover alternatives, modifications, and equivalents as may be included within the spirit and scope of the invention as defined by the appended claims.

### Section II: Description of the Aspects and Embodiments of the Invention

The present invention provides, in a first aspect, a receptacle comprised of a single unit. The receptacle allows for the necessary aeration and solution volume maintenance to grow the plant. The receptacle is comprised of both transparent and opaque components. The receptacle can incorporate air and/or pump line notches. In some embodiments, the receptacle has a handle.

In one embodiment, the transparent aspect(s) are comprised of vertical lines. In a second embodiment, the transparent aspects are comprised of horizontal lines. In a third embodiment, the transparent aspects are comprised of diagonal or asymmetric lines.

In a fourth embodiment, the receptacle is equipped with a top enclosure. In a seventh embodiment, the receptacle has fixtures to enable affixing a plant support structure. In a fifth embodiment, the receptacle is attached to a reservoir which control the solution volume in said receptacle.

In a second aspect, the present invention includes a system comprised of multiple receptacles. The receptacles allow for the necessary aeration and solution volume maintenance to grow the plant(s). The receptacles are comprised of both transparent and opaque components. The receptacles incorporates air and/or pump line notches. In some embodiments, the receptacles have handles.

In one embodiment, the transparent aspects are comprised of vertical lines. In a second embodiment, the transparent aspects are comprised of horizontal lines. In a third embodiment, the transparent aspects are comprised of diagonal or asymmetric lines.

In a fourth embodiment, the receptacles are equipped with top enclosures. In a seventh embodiment, the receptacles have fixtures to enable affixing a plant support structure. In a fifth embodiment, the receptacles are attached to a reservoir which controls the solution volume in said receptacle.

### Section III: Examples

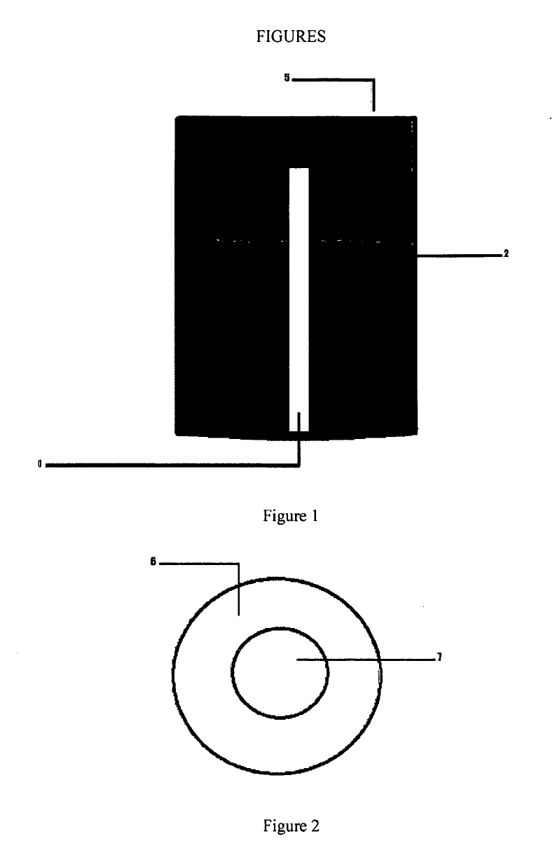

The invention will now be described in greater detail by reference to the following non-limiting examples. The examples refer to FIGS. 1-5 for clarity only. Additional sizes, volume capacities, and tangential use of multiple units is contemplated by the invention.

FIG. 1 is a front side view of the receptacle. As illustrated in FIG. 1, the receptacle is comprised of both a transparent component 1 and an opaque component 2. In FIG. 1 the transparent component is depicted in the vertical orientation but other orientations may be utilized. Said transparent component can be either a differently colored section of a contiguous material comprising the receptacle or comprised of a second material cohesively joined with the material constituting the opaque portion of the receptacle. The transparent component illustrated in FIG. 1 enables the receptacle user to assess the solution volume.

The receptacle illustrate in FIG. 1 also comprises a top enclosure 5 to regulate solution evaporation and provide protection from exposure to other elements.

The receptacle illustrated in FIG. 1 is cylindrical in shape, but the receptacle may also be any other shape. The receptacle illustrated in FIG. 1 is capable of holding five gallons of solution, but the receptacle may also be created in any other size to hold any other volume.

FIG. 2 shows a top view of the receptacle. The top view shows a straight-on view of the top enclosure 5. The top enclosure is comprised of a solid component 6 and an open component 7. The solid component provides for regulation of solution evaporation. The open component allows a plant to grow up out of the receptacle.

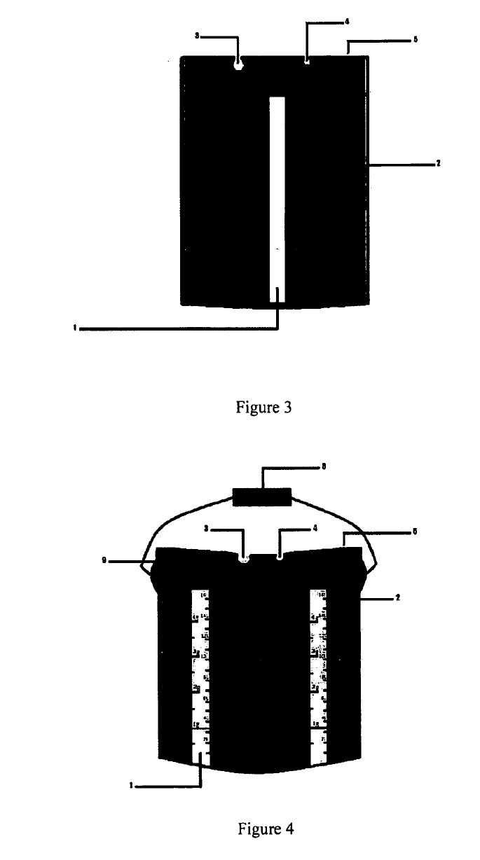

FIG. 3 is a front view of an exemplary receptacle with an air notch 4 and pump notch 3 in accordance with the present invention. The purpose of the air and pump lines is to aerate and maintain the solution volume respectively in accordance with the user's deep water culture growth parameters.

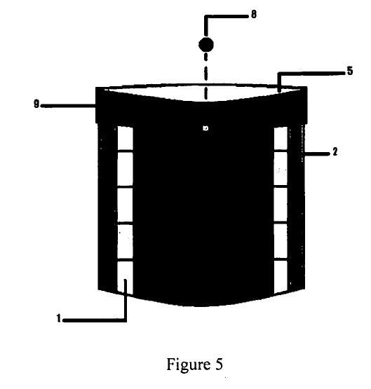

FIG. 4 is a front view of the preferred embodiment of the invention. FIG. 4 shows a deep water culture receptacle comprising two transparent components 1, a solid component 2, an air notch 4 and a pump notch 3. The transparent components have marking which enable the user to measure the solution volume. The preferred embodiment also comprises a top enclosure 5, a reinforced rim 9, and a wire handle with grip 8. The wire handle and foam grip can be attached to the receptacle to enable convenient movement of the receptacle. The wire handle and foam grip can be fashioned of any equivalent which provides the same means of movement. The reinforced rim can provide extra structural support to the receptacle.

The receptacle illustrated in FIG. 4 may also be equipped with external fixtures to enable the attachment of an external plant support structure.

The receptacle illustrated in FIG. 4 may also be used as a reservoir for solution which can be fed through the pump line, or another solution transfer mechanism, into another receptacle(s).

FIG. 5 is a side view of the preferred embodiment of the invention. FIG. 5 shows a deep water culture receptacle comprising two transparent components 1, a solid component 2, a top enclosure 5, a reinforced rim 9, and a wire handle with grip 8.

The preferred embodiment as illustrated in FIGS. 4 and 5 conforms with the description above and has the following measurements:

Top Outer Diameter: 11¾ inches

Top Inner Diameter: 11¼ inches

Receptacle Height: 14½ inches

Reinforced Rim Height Minimum: 2¼ inches

Reinforced Rim Height Maximum: 3 inches

Transparent Component Width: 11/16 of an inch

Top Enclosure Outer Diameter: 12⅛ inches

Top Enclosure Inner Diameter: 5⅞ inches

The receptacle dimensions illustrated in FIGS. 3 and 4 correspond to a five gallon cylindrical receptacle. The reinforced rim option is preferable because it provides extra support where the handle attaches which facilitates moving the receptacle when full. The reinforced rim also provides structural support for the receptacle and plant(s). The transparent component width illustrated in FIGS. 4 and 5 provides the preferred ratio of translucent to opaque receptacle material to enable easy solution level assessment while preventing undesirable microorganism growth in said solution.

1. A receptacle for growing a plant or plants by submerging the roots in a solution comprising:
a transparent component of said receptacle which allows for viewing the solution level; and
an opaque component of said receptacle which protects the receptacle from penetration of ultraviolet light.

2. The receptacle of claim 1 further comprising:
notches for air or solution pump lines; and
a top enclosure which provides for protection from evaporation.

3. The receptacle of claim 1, wherein said transparent component is comprised of a singular vertical, horizontal, or diagonal section, and said opaque component comprises the remainder of the receptacle.

4. The receptacle of claim 1, wherein said transparent component is comprised of multiple vertical, horizontal, or diagonal sections, and said opaque component comprises the remainder of the receptacle.

5. The receptacle of claim 1, wherein said top enclosure includes a hole for a plant to protrude from.

6. The receptacle of claim 1, further comprising fixtures to enable affixing a plant support structure.

7. The receptacle of claim 1, further comprising a handle.

8. The receptacle of claim 7, further comprising a foam grip.

9. The receptacle of claim 1, further comprising a reinforced rim.

10. The receptacle of claim 1, further comprising a means of controlling the solution volume in said receptacle.

11. A system of receptacles for growing a plant or plants by submerging the roots in a solution comprising:
a transparent component of said receptacles which allows for viewing the solution level; and
an opaque component of said receptacles which protects the receptacle from penetration of ultraviolet light.

12. The receptacles of claim 11 further comprising:
notches for air or solution pump lines; and
top enclosures which provides for protection from evaporation.

13. The receptacles of claim 11, wherein said transparent component is comprised of singular vertical, horizontal, or diagonal sections on each receptacle, and said opaque component comprises the remainder of the receptacles.

14. The receptacles of claim 11, wherein said transparent component is comprised of multiple vertical, horizontal, or diagonal sections on each receptacle, and said opaque component comprises the remainder of the receptacles.

15. The receptacles of claim 11, wherein said top enclosures includes holes for a plant to protrude from.

16. The receptacles of claim 11, further comprising fixtures to enable affixing plant support structures.

17. The receptacles of claim 11, further comprising handles.

18. The receptacles of claim 17, further comprising foam grips.

19. The receptacles of claim 11, further comprising reinforced rims.

20. The receptacles of claim 11, further comprising a means of controlling the solution volume in said receptacles.
